(19) United States
(12) Patent Application Publication
(10) Pub. No.: US 2015/0154570 A1
(43) Pub. Date: Jun. 4, 2015

(54) Multi-Channel Transaction System for Transferring Assets Between Accounts at Different Financial Institutions

(71) Applicant: CASHEDGE, INC., New York, NY (US)

(72) Inventor: Sanjeev Dheer, New York, NY (US)

(21) Appl. No.: 14/615,198

(22) Filed: Feb. 5, 2015

Related U.S. Application Data
(63) Continuation of application No. 11/584,783, filed on Oct. 19, 2006.
(60) Provisional application No. 60/728,196, filed on Oct. 19, 2005.

(51) Int. Cl. G06Q 20/04; G06Q 20/24; G06Q 20/26; G06Q 20/40

(52) U.S. Cl. CPC G06Q 20/04; G06Q 20/40; G06Q 20/24; G06Q 20/26

(57) ABSTRACT

Embodiments of a system for providing an integrated financial system to facilitate the transfer of funds among accounts held at different financial institutions and over different networks are described. The system executes a transaction involving a withdrawal of assets from a first account at a first financial institution and a deposit of at least a portion of the withdrawn assets to a second account at a second financial institution. The first account and the second account are maintained by different corporate entities, and may have the same or different account holders. The financial institutions are coupled to one another through different types of networks. The transaction is broken down into separate debit and credit legs. An integrated transfer process selects the optimum network to perform each leg of the transaction based upon constraints associated with the transaction and user preferences, such as cost and speed of the transaction, and restrictions or rules imposed by the networks and/or the financial institutions.

### CROSS-REFERENCE TO RELATED APPLICATIONS

The current application claims the benefit under 35 U.S.C. §119(e) of Provisional Application No. 60/728,196, entitled “Integrated Funds Transfer Hub,” and filed on Oct. 19, 2005.

### FIELD

Embodiments of the invention relate generally to financial transaction computer networks, and more specifically, to a transaction process for transferring funds between accounts at different financial institutions over different payment networks.

### BACKGROUND

Financial institution customers (both individuals and businesses) typically maintain multiple financial accounts at one or more financial institutions. Financial institutions include, for example, banks, savings and loans, credit unions, mortgage companies, lending companies, and stock brokers. The financial accounts that are maintained may include asset accounts (such as savings accounts, checking accounts, certificates of deposit (CDs), mutual funds, bonds, and equities), debt accounts (such as credit card accounts, mortgage accounts, home equity loans, overdraft protection, and other types of loans), and pool accounts, which are accounts maintained at a financial institution for purposes of reloading debit cards for domestic or international transfers.

Customers may choose to transfer funds among their accounts for a variety of reasons, such as to maximize the interest earned in asset accounts or minimize the interest paid in the debt accounts. In general, customers wishing to transfer funds between different accounts are required to execute the necessary transactions themselves. If the accounts are maintained at the same financial institution or branches of the same corporation, the transaction can usually be accomplished through automatic transfer mechanisms provided by the financial institution. If, however, the accounts are maintained at different financial institutions, i.e., financial institutions owned or operated by different corporate entities or subdivisions, the customer must typically perform the transfer manually by visiting either or both of the financial institutions and requesting the appropriate fund transfers, and then effectuating the transfer by check or bank wire.

With the growth of online banking, customers have the ability to transfer funds from different accounts using their home computer systems. Without the use of checks, phone calls, or bank visits, funds can often be transferred among different accounts using electronic fund networks. However, many different types of networks have been developed for use by different financial institutions and account or transaction types, and therefore, each type of transfer generally requires a different network and different routing algorithms. Certain types of transfers among different financial institutions may be disallowed or made very difficult due to regulatory restrictions or risks associated with the transfer. In such a case, rigorous validation rules may need to be applied to perform the transaction, thus driving up the cost and complexity of the transfer. Additionally, banks and other financial institutions may impose different limits and rules for each type of transfer. For example, they may require customers to make a phone call for certain types of wire transfers above a certain transfer amount, and may require additional validations checks. Just as importantly, they may have different fees and delivery speeds for different types of transfers. Thus, a specific type of transfer may cost a certain amount of money and take a certain amount of time for one financial institution, but cost appreciably more and/or take much longer at a another financial institution.

These different variables create tremendous complexity for customers, as they must each decide what type of transfer they wish to make based on all of these considerations. They also practically limit the applicability of online banking networks to fund transfers among different financial institutions, thus requiring that customers continue to utilize old manual methods to perform their own transactions, thus denying them the ability to efficiently and conveniently manage their financial affairs.

### BRIEF DESCRIPTION OF THE DRAWINGS

Embodiments are illustrated by way of example and not limitation in the figures of the accompanying drawings, in which like references indicate similar elements and in which:

FIG. 1 illustrates a computer network environment that implements one or more embodiments of an integrated transfer process for multi-channel fund transactions.

FIG. 2 illustrates an example of the interaction between a particular pair of financial institution servers, a client computer, and a financial management system, according to an embodiment.

FIG. 3 illustrates a network environment in which funds are transferred between various financial institutions using multiple payment and/or messaging networks, under an embodiment.

FIG. 4 is a block diagram of components and modules of an integrated transfer process, under an embodiment.

FIG. 5 is a flowchart that illustrates the process of performing a transaction between two different financial institutions, according to an embodiment.

FIG. 6 is a block diagram that illustrates functional components of a multi-channel transaction system, according to an embodiment.

FIG. 7 is a flow diagram that illustrates reconciliation of multi-channel real time transfers, under an embodiment.

### DETAILED DESCRIPTION

Embodiments of a system for providing an integrated financial system to facilitate the transfer of funds among accounts held at different financial institutions and over different networks are described. In the following description, numerous specific details are introduced to provide a thorough understanding of, and enabling description for, embodiments of the multi-channel fund transfer process. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

The system and methods described herein execute a transaction involving a withdrawal of assets from a first account at a first financial institution and a deposit of at least a portion of the withdrawn assets to a second account at a second financial institution, or the creation of liability resulting from a withdrawal from a line of credit, or similar account. The first and second accounts are maintained by different corporate entities or subdivisions of these corporate entities, and may have a common account holder or different account holders. The financial institutions are coupled to one another through different types of networks. The transaction is broken down into separate debit and credit legs. An integrated transfer process selects the optimum network to perform each leg of the transaction based upon constraints associated with the transaction and user preferences, such as cost and speed of the transaction, restrictions or rules imposed by the networks and/or the financial institutions, and constraints of the network.

The financial institutions and networks can be domestic or international, with a portion of the network distributed at least partially in the United States and in one or more other foreign countries, and/or with the financial institutions located in the U.S. and other countries.

As used herein, the terms “account holder”, “customer”, “user”, and “client” are interchangeable. “Account holder” refers to any person having access to an account. A particular account may have multiple account holders, e.g., a joint checking account having husband and wife as account holders or a corporate account identifying several corporate employees as account holders. Various financial account and financial institution examples are provided herein for purposes of explanation. However, it will be appreciated that the system and procedures described herein can be used with any type of asset account and any type of debt account. Example asset accounts include savings accounts, money market accounts, checking accounts (both interest-bearing and non-interest-bearing), certificates of deposit (CDs), mutual funds, bonds, and equities. Example debt accounts include credit card accounts, mortgage accounts, home equity loans, overdraft protection, margin accounts, personal loans, and other types of loans. Example financial institutions include banks, savings and loans, credit unions, mortgage companies, mutual fund companies, lending companies, and stock brokers.

Various attributes or preferences associated with financial transactions or transfers among accounts are discussed herein, and include the cost or fees associated with a transaction, the delivery speed or time to complete the transaction, and the risk of failure associated with the transaction. Although particular examples are discussed herein with reference to these specific preferences, it will be appreciated that the methods and systems described herein are applicable to any type of transaction attribute.

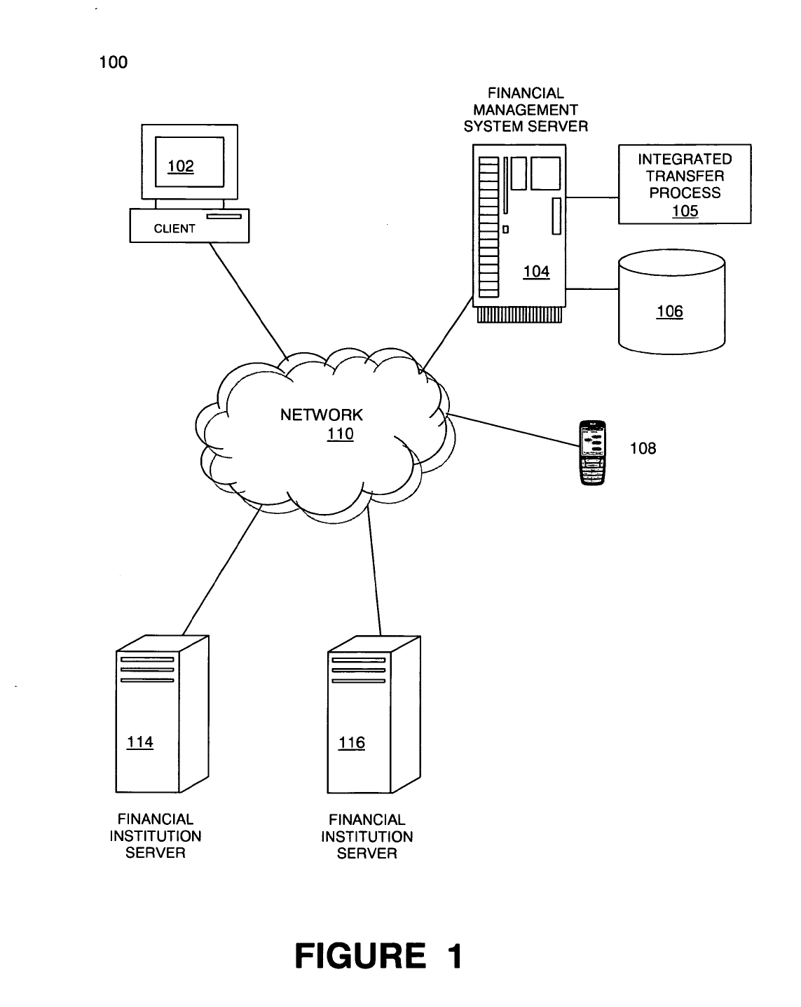

Aspects of the one or more embodiments described herein may be implemented on one or more computers executing software instructions. The computers may be networked in a client-server arrangement or similar distributed computer network. FIG. 1 illustrates a computer network system 100 that implements one or more embodiments, and in which various servers, computing devices, and financial management systems exchange data across a communication network. The network environment of FIG. 1 includes multiple financial institution servers 114 and 116 coupled to a communication network 110. Other server computers, such as financial management system server 104 may also be coupled to network 110. The network environment 100 serves to couple the various server computers to client computers 102 and 108 operated by customers (“users”) of services provided by the entities operating the server computers.

The communication links shown between the network 110 and the various client and server computers shown in FIG. 1 can use any type of communication medium and any communication protocol. For example, one or more of the communication links shown in FIG. 1 may be a wireless link (e.g., a radio frequency (RF) link or a microwave link) or a wired link accessed via a public telephone system or another communication network. The network interfaces between the server and client computers to the network 110 may include one or more routers that serve to buffer and route the data transmitted between the server and client computers. Certain devices, such as servers, may be coupled to a local area network (LAN), which is coupled to network 110.

Client computer 102 may access network 110 in different ways. First, client computer 102 may directly access network 110, for example, by using a modem to access a public telephone network (e.g., a public switched telephone network (PSTN)) that is coupled to network 110. Client computers may be any class of computing device, such as personal computer, workstation, and so on. Another class of client computers is represented by mobile client 108. Mobile client (wireless device) 108 can be a mobile computing or communication device, such as a notebook computer, personal digital assistant (PDA), mobile phone, game console, or any similar class of mobile computing device with sufficient processing and communication capability that is capable of communicating with other devices via a wireless connection.

Network 110 may be any type of electronic network using any communication protocol for the transmission of data or the exchange of funds between computers linked through the network. Further, network 110 may include one or more sub-networks (not shown) which are interconnected with one another. In one embodiment, network 110 comprises the Internet, and may include one or more Wide Area Networks (WAN), Local Area Networks (LAN), or any combination thereof. In one embodiment, the one or more of the server computers function as a World-Wide Web (WWW) server that stores data in the form of web pages and transmits these pages as Hypertext Markup Language (HTML) files over the Internet 110 to the client computer 102. For this embodiment, the client computer 102 typically runs a web browser program to access the web pages served by server computers and any available content provider or supplemental server. For this embodiment, client computer 102 may access the Internet 110 through an Internet Service Provider (ISP).

For the embodiment of FIG. 1, each of the financial institution servers 114 and 116 is associated with a particular financial institution and serves to store data, such as customer account data, and execute computer-implemented processes for that financial institution. System 100 also includes a financial management system server 104 performs that executes an integrated transfer process 105. The financial management system server can be configured to perform various financial application tasks related to accounts maintained by the user of client computer 102 at the one or more financial institutions maintaining servers 114 and 116. These include various account management functions, as well as transfer functions that are capable of initiating the automatic transfers of funds between accounts at one or more financial institutions 114 and 116.

In general, wireless device 108 and client computer 102 allow a user to access information via the network 110. For example, the user can access account information from one of the financial institution servers 114 or 116 and request transfers using the financial management system server 104. In an embodiment in which the network 110 includes an online banking system, the user of client computer 102 logs onto the online banking system using protocols defined by the system, and accesses funds transfer mechanisms available through the financial management system server 104 to effect the transfer of funds between accounts maintained on different financial institution servers 114 and 116. The interface to the accounts held at the financial institution servers may be provided by a service provider, which can be a third party or the financial institution itself.

In one embodiment, the network client computer 102 is configured to run a native or web-based financial application program that allows the user to access and manipulate account information stored on one or more the server computers. This client-side application can comprise one or more standalone programs executed locally on the client computer 102, or it can be portions of a distributed client application run on the client or a network of client computers.

As shown in FIG. 1, financial management system server 104 executes a server-side integrated transfer process 105 for multi-channel funds transfers. The integrated transfer process includes functional components that perform the tasks of determining the optimum network to perform fund transfers using the available networks between the financial institution servers, executing the transactions, and providing a single integrated interface to the user of client 102 or 108. The process 105 may represent one or more executable programs modules that are stored within financial management system server 104 and executed locally within the server. Alternatively, the integrated transfer process may be stored on a remote storage 106 or processing device coupled to server 104 or network 110 and accessed by server 104 to be locally executed. In a further alternative embodiment, the integrated transfer process 105 may be implemented in a plurality of different program modules, each of which may be executed by two or more distributed server computers coupled to each other, or to network 110 separately.

Data for any of the applications contained within or associated with financial applications used by the client computer 102 may be provided by a data store 106 that is closely or loosely coupled to any of the server and/or client computers. Thus, although data store 106 is shown coupled to server 104, it should be noted that content data may be stored in or more data stores coupled to any of the computers of the network, such as client 102 or to devices within the network 110 itself.

Each of the client and server computers shown in FIG. 1 may be embodied on one or more circuits or machines that include at least a central processing unit (CPU) coupled through a bus to various functional units, such as memory, arithmetic/logic blocks, and input/output (I/O) interfaces. The I/O interfaces can be connected directly or indirectly to one or more on-board or off-board peripheral devices, such as disk drives, communication devices, and so on. The CPU can also be coupled to a network controller, which provides access to network 110 through a network port. The computers are programmed using instructions stored at different times in the various computer-readable media.

For purposes of illustration, programs and other executable program components are illustrated herein as discrete blocks, although it is understood that such programs and components reside at various times in different storage components of the computer, and are executed by the computer's processor. For this purpose, the terms “components,” “modules,” “programming blocks,” and so on are used interchangeably to refer to software or firmware programs, or hardware or firmware logic circuits that are configured to execute specific computer-implemented processes. Thus, the systems and procedures described herein can be implemented in hardware or a combination of hardware, software, and/or firmware. For example, one or more application specific integrated circuits (ASICs) can be programmed to carry out the systems and procedures described herein.

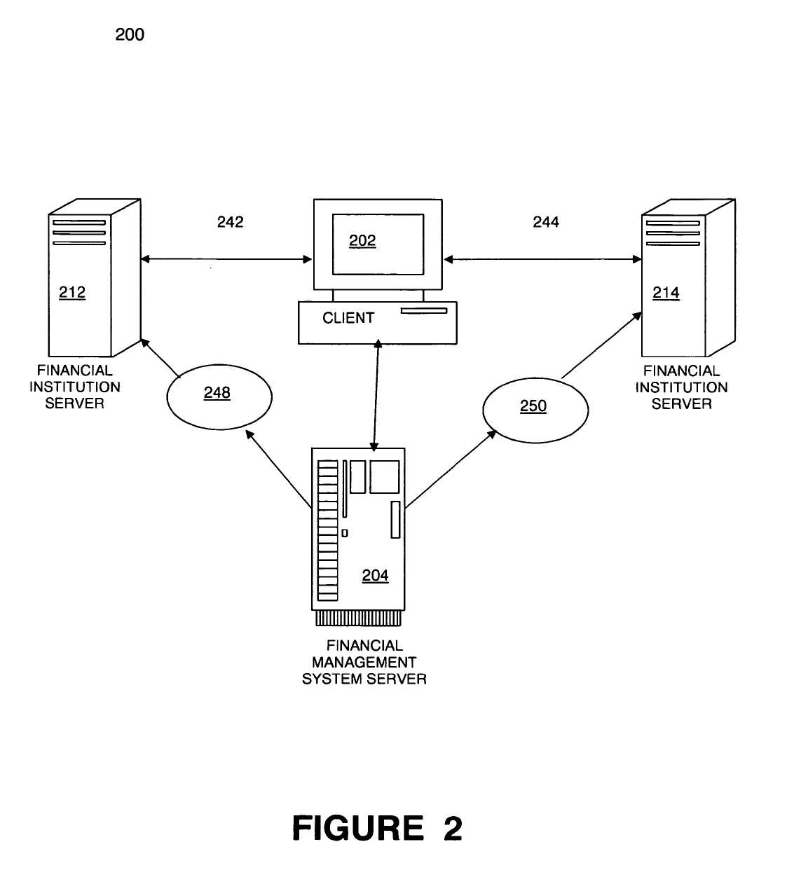

FIG. 2 illustrates an example of the interaction between a particular pair of financial institution servers 212 and 214, payment networks 248 and 250, a client computer 202, and a financial management system 204. In this example, each financial institution server 212 and 214 is associated with a different financial institution. Client computer 202 is capable of accessing financial institution server 212 via a communication link 242, or accessing financial institution server 214 via a communication link 244. Typically, the client computer is coupled to only one of the financial institution servers, but in some cases it might be coupled to more than one financial institution server. One or both of the links 242 or 244 may represent online banking interfaces that allow the user of client computer 202 to retrieve account information from one or both of the financial institution servers 212 and 214. Client computer 202 is also capable of interacting with financial management system 204 via a communication link 246. The user of client computer 202 may access financial management system 204 to automatically initiate the transfer of funds between accounts held on the financial institution servers 212 and 214.

For the embodiment of system 200, financial management system server 204 is coupled to the two financial institution servers 212 and 214 via payment networks 248 and 250, respectively. These payment networks 248 and 250 allow the financial management system 204 to execute transactions on the financial institution servers on behalf of the user of client computer 202.

Although the figures herein generally illustrate a transaction involving two financial institution servers, it should be noted that transactions processed by financial management system server 104 on behalf of a client 102 may involve any number of accounts held on any number of financial institution servers. In general however, any transaction involving any number of accounts and entities is first decomposed into discrete individual steps involving specific transfers between pairs of accounts.

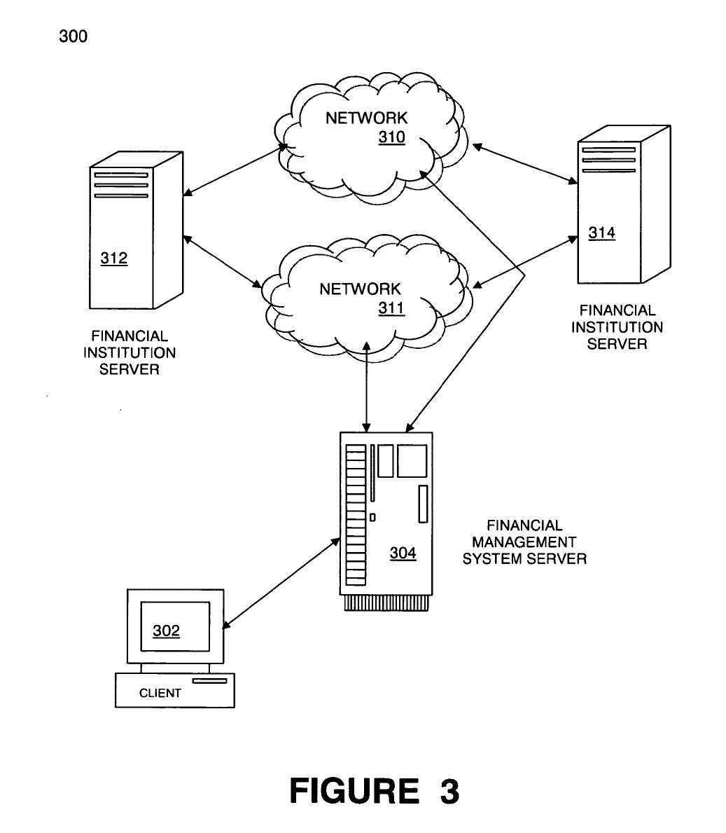

FIG. 3 illustrates an environment 300 in which funds are transferred between various financial institutions using multiple payment networks, under an embodiment. In this embodiment, a first financial institution 312 is coupled to a second financial institution network 314 over two or more payment and/or messaging networks 310 and 311. Other financial institutions (not shown) may also be coupled to the financial institutions over the same payment networks or other different payment networks. For the embodiment of FIG. 3, a financial management system 304 is also coupled to both of the payment networks 310 and 311. The financial management system 304 performs account transfers and other account management functions on behalf of a client 302 user who may hold accounts at both financial institution servers 312 and 314. Alternatively, the user may effect a transaction between accounts at one financial institution for another person or other third party who owns an account at the second financial institution. The transactions may be real-time transactions or they may be batch transactions, in which the transaction is delayed or multiple transactions are consolidated and sent at once.

If a fund transfer is required between accounts at the two financial institutions 312 and 314, the financial management system 304 generates a fund transfer instruction based on a request by the user. In general, fund transfer instructions of any type can be transmitted over a messaging network, whereas the actual transfer of funds in response to such an instruction occur over a payment network. It should be noted that either or both of the networks 310 and 311 in FIG. 3 could include both messaging and payment networks. In certain instances, transfer instructions and other types of messages can also be sent over the payment networks.

The fund transfer instruction may include the account information (e.g., account numbers, names or other identifiers) and financial institution information for the accounts involved, the amount of money or funds to be transferred, and other information. In general, a transfer instruction is separated into two different transactions: a first transaction that withdraws the appropriate funds from an account at one financial institution and a second transaction that deposits those funds into an account at the second financial institution. Although two different transactions occur, the fund transfer appears as a single transaction to the user or account holder. Although the two transactions may occur over the same payment network, in some cases, it is either not possible to use a single network or more optimum to use two different networks to accomplish each transaction. In system 300, the two networks 310 and 311 can be used for each of the different transactions between the financial institutions 312 and 314. The payment networks within networks 310 and 311 can be any type of public or proprietary network, such as the federal wire system (Fed Wire), an Electronic Funds Transfer (EFT) network (such as for automated teller machines), the Federal Automated Clearing House (ACH) network, a debit or credit card network, the Open Financial Exchange (OFX) network, the SWIFT (Society for Worldwide Interbank Financial Telecommunication Network), or any bank proprietary or custom LAN or WAN, or similar type of network. Likewise, the messaging networks within networks 310 and 311 can comprise any type of public or proprietary network, such as EFT, credit card, or proprietary bank networks.

The user can maintain different types of accounts at the different financial institutions 312 and 314, such as savings and checking accounts, credit card accounts, CDs or loans, and so on. The use of different networks 310 and 311 allows the transfer of funds between the two financial institutions and among all of the possible accounts held in the two different institutions using the most optimum network with regard to speed of transaction, cost, security, probability of success (risk), and other similar attributes. For example, if the user transfers funds from a checking account in financial institution 312 to a savings account in financial institution 314, the funds may be debited from financial institution 312 using an EFT (e.g., ATM) network and credited to financial institution 314 using an ACH network. In one embodiment, an integrated transfer process 105 includes channel selection logic and applies business rules to determine the best network routing scheme for performing the transfer requested by the user in a manner that is transparent to the user.

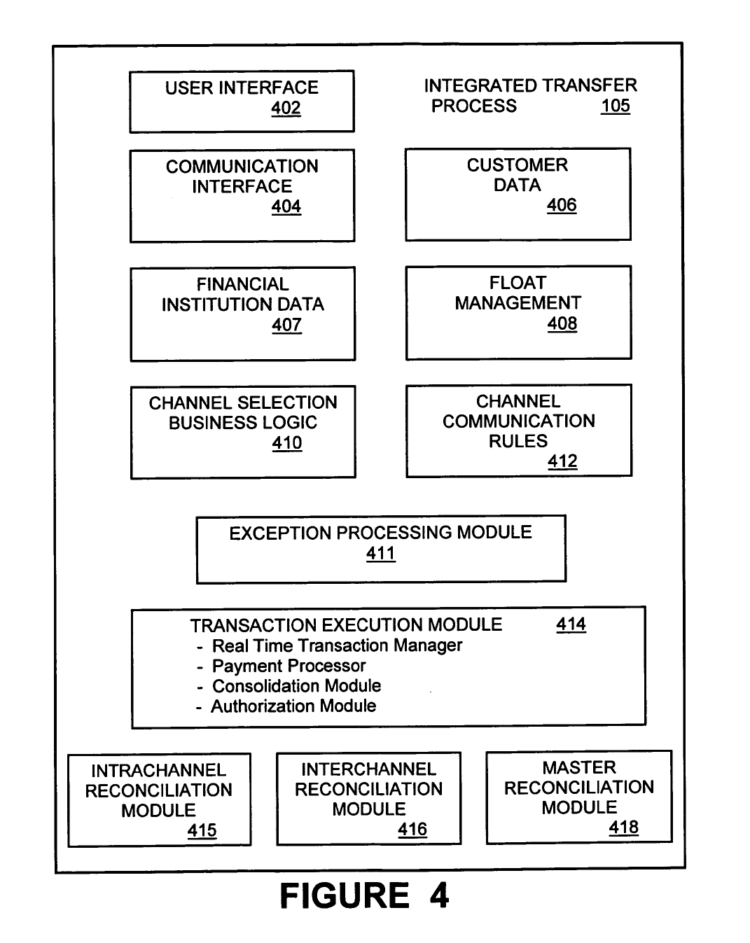

In system 100 of FIG. 1, the financial management system server 104 executes an integrated transfer process that includes, among other things, a route optimization process that determines the optimum route to perform the debit (withdrawal) and the credit (deposit) for a single transfer transaction between accounts held at different financial institutions, such as financial institutions 112 and 114. FIG. 4 is a block diagram of components and modules of an integrated transfer process, under an embodiment. A communication interface 404 allows the financial management system server 104 to communicate with other computing systems, such as servers, client computers, and portable computing devices. In one embodiment, communication interface 404 is a network interface to a LAN, which is coupled to another data communication network, such as the Internet. The financial management system server stores customer data 406, such as customer account information and user preferences with regard to fund transfers. It also stores certain relevant financial institution data 407 for the financial institutions in the network. The financial institution data 407 includes, for example, transaction routing data, account offerings, account interest rates, and customer requirements and guidelines, such as minimum account balances, and so on. The integrated transfer process also includes a float management module 408 that computes the float within the channels and across the channels. Any mismatch in timing between the legs of transaction can result in an amount floated by one of the financial institutions. The float management module 408 computes the net float amount and levies a fee to the finance institution which owes the float. Alternatively, the float can be added to the price of the transaction.

In one embodiment, the integrated transfer process provides a user interface 402 that prompts the user for certain information regarding a desired account transaction. In general, any transaction involves a transfer of at least some monetary funds from one account held by the user from a first financial institution into a different account, also held by the user, but at a second financial institution. This transfer is essentially a two step process in which, during the first step, funds are pulled from (debited) an account at a first financial institution, and in the second step, the funds or a portion of the funds placed into (credited) to an account at a second financial institution. During the transaction, other processes may have occurred, such as currency exchange, rerouting of certain funds, docking of fees/penalties, or other similar manipulations, however the basic transaction involves simply the withdrawal of money from one account for deposit into a second account. For purposes of discussion the term “leg” can also be used to describe either of the steps involved in a fund transfer between the financial institutions.

In general, a transaction involves two legs. In certain instances, a transaction can have three or more legs, such as a debit and two or more credit operations or a credit and two or more debit operations, in what are essentially consolidated transactions. Furthermore, any of the legs of the transaction can be either a real time transaction or a batch transaction. In general, real time transactions utilize the messaging network, and batch transactions utilize both the messaging and payment networks, although both types of transactions (real time and batch) can utilize both types of networks (messaging and payment). In one example of a transaction, leg 1 could be a real time credit card transaction that goes through a messaging network and leg 2 could be a real time ATM transaction that also goes through a messaging network. In general, net settlement occurs when the network or networks send a net settlement transaction to the processing bank, and the net settlement amount is generally equal to the value of the debits minus the credits. In this example, there will be two settlements, one will be received from the credit card network into the processing bank, and the other will be from the ATM network. Both of these entries are ACH transactions into the processing bank. In a second example, leg 1 is a batch ACH transaction that goes through a message/payment network and leg 2 is a real time ATM transaction that goes through a messaging network. In this example, net settlement occurs when the ACH entry is processed in batch mode. The ACH entry also serves as a message. For the second leg, the message is sent out and settlement occurs via and ACH transaction at the processing bank. These are two examples among many other possible scenarios and are meant to depict some of the possible combinations of transaction types and networks.

As further shown in FIG. 4, the integrated transfer process 105 includes a user interface component 402. Through the user interface 402, the user is prompted to provide certain information relevant to the transfer. In one embodiment, the user simply specifies the source and target accounts (by account number or other identifier), the amount of funds to be transferred (transaction size), and any relevant preference information, such as minimum transaction speed. In this embodiment, the user need not explicitly specify the type of transfer (e.g., money transfer, credit card advance, loan payment, and so on). Instead, the integrated transfer process 105 derives the type of transaction being performed (e.g., credit card, loan payment, etc.) based on the identity of the first and second accounts, and then automatically determines the optimum network to accomplish the fund transfer based on three basic parameters comprising: 1) the user specifications or preferences (e.g., transaction size and transaction speed); 2) the risk tolerance for the transaction (i.e., the minimum chance of success required by the service provider or financial institution); and 3) the network constraints (e.g., maximum allowable transaction amount, minimum time required, and so on.)

In certain user interface implementations, the user could also be prompted to explicitly provide additional information besides the account numbers and transaction size, such as the type of transaction, as well as certain preference data including the maximum service charge allowed for the transaction, the maximum amount of time allowed for the transaction, the risk tolerance with regard to success or failure of the transaction, and other similar parameters. The user interface 402 may also be configured to prompt the user for additional information during the course of the transaction. The user may be required to register the accounts or specify certain characteristics associated with an account, such as an account that makes recurring payments, or that utilizes a third party account. The user interface can be implemented in a number of ways that are known to those in the graphical user interface art, such as through the use of drop-down menus, data entry fields, and context sensitive pop-up menus through which the system collects the relevant information required from the user.

As shown in FIG. 4, the integrated transfer process includes channel business selection logic 410, which determines which channel a particular leg of the transaction should be routed through. For purposes of discussion, the term “channel” refers to a particular network or portion of network, such as network 310 or 312 between the two financial institutions involved in a transfer. As stated above, the possible channels between the two financial institutions could include networks such as EFT, ACH, OFX, credit card, proprietary bank networks, and the like. The channel selection business logic utilizes the information received from the user regarding the service or transaction type, as well as the user preferences with regard to transaction cost, time, risk, and so on. In certain cases, if time is critical, a faster channel, such as EFT may be selected by the channel selection business logic 410, but this may increase the cost of the transaction. However, if the user indicates that cost is not to exceed a certain value, a less costly channel may be utilized instead. The size of the transaction may also dictate which network is used because some networks may have maximum transfer limits. Settlement finality can also be a factor that determines the selection of a network.

In general each channel or network type (EFT, ACH, OFX, and so on) may dictate a specific set of protocols for messages, payments, and the like. The channel communications rules component 412 determine the sequence of messages and payments that are required for the selected channel. This component also conditions the messages to conform to the protocols and formats required by the different networks. For example, present ACH networks have different message transmission requirement from present EFT networks, therefore a message intended to be transmitted over an ACH network would be packaged differently from a message that performs the same function, but that is transmitted over an EFT network.

Once the messages for a particular leg of the transaction have been properly formulated and formatted for the selected network, a transaction execution module 414 then executes the financial transaction on behalf of the user by implementing the channel communication rules for the selected channel for the present leg of the transaction. The transaction execution module 414 includes submodules, such as a real time transaction manager, a payment processing engine, an authorization module to verify the existence and viability of the accounts, and a consolidation module for consolidating multiple individual transactions into a single transaction (e.g., consolidating debit/credit to suspense account). In general, the financial institution servers include a module that validates the identity of the user (such as through the use of passwords or unique identifiers). Alternatively, a separate user and account ownership verification module may be included in the integrated transfer process that verifies that the user accessing financial management system 104 is authorized to access a particular account.

An exception processing module 411 generally detects and resolves the problematic transactions, such as those that result from unauthorized users, transactions that violate any business rules or do not conform to network constraints, and so on. Other exception conditions may result from violation of governance rules that surround certain account types, such as 401K accounts, and so on. The exception processing module can also include an integrity verification module that can detect fraudulent transactions. The exception processing module includes sub processes to identify the exception condition, isolate the problem transaction for further review, and automatically resolve the transaction, or abort the entire transaction, if necessary.

The integrated transfer process 105 also includes various reconciliation components, such as an intrachannel reconciliation module 415 that reconciles each leg of a transaction separately; as well as an interchannel reconciliation module 416 that reconciles transactions between channels, and a master reconciliation module 418 that reconciles transactions as a whole.

Other modules to manage the customer accounts and provide various financial services may also be included. Any or all of the individual modules illustrated in FIG. 4 can be contained in a single execution domain, such as the integrated transfer process 105, or they may be distributed among different execution domains that are executed by the financial management system server 104, either locally or remotely.

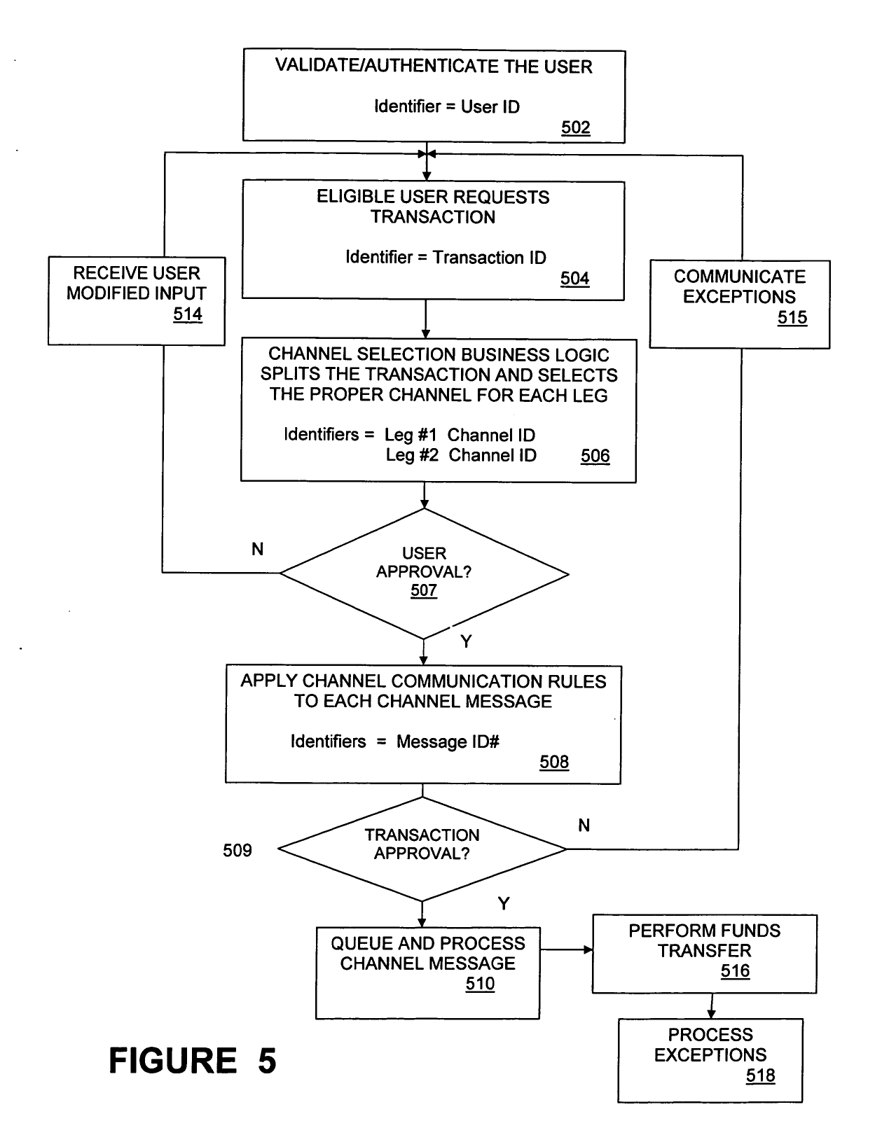

FIG. 5 is a flowchart that illustrates the process of performing a transaction between two different financial institutions, according to an embodiment. In step 502, the user is validated to ensure that only the appropriate users can access the accounts and request transfers. This validation can be done by the service provider through which the user is requesting the fund transfer service, by the financial institution(s) and/or through a financial management system server process. The user validation or authentication process 502 can be performed using password control, biometric identifier, or other suitable means. Once the user is authenticated to be an eligible user, the process begins when the user requests a transaction that causes funds to be transferred from an account at a first institution to an account at a second institution, block 504. The transaction is assigned a transaction ID, which serves as one of several identifiers used by the integrated transfer process to manage the process; likewise, the user may be assigned a unique user ID for use by the system.

The channel selection business logic of the integrated transfer process splits the transaction into the appropriate debit and credit legs that comprise the transaction. Once the transaction has been split into the two (or more) legs, the channel selection business logic selects the proper channel for each leg, block 506. The identifiers in this block consist of the channel ID for the first leg, and the channel ID for the second leg. Each channel can be a separate network or portion of a network coupling the first financial institution to the second financial institution.

For the embodiment shown in FIG. 5, the system provides feedback to the user after the channels for each leg have been selected. This feedback includes an indication of the transaction cost and time, as well as any other relevant information. The user then has the opportunity to approve the transaction, cancel the transaction, or request a modification. In block 507, the process determines whether or not the user approves the transaction and accepts the cost, time and other characteristics of the transaction. If the user does approve the transaction, the user is allowed to modify the input and relax certain preferences or parameters, block 514. The system then processes the modified transaction request from block 504. If the user does approve the transaction, the process proceeds by applying the appropriate channel communication rules to each message transmitted over the two separate channels, block 508. The messages comprise any data exchanges or other protocols that are required to facilitate the transaction. Each message is assigned a unique message ID.

In block 509 the process determines whether the channel communication rules allow the transaction to continue. If not, an exception condition exists, in which case, the exception processing module 411 automatically isolates and processes the exception. The exception is communicated to the user, block 515, who is then given the opportunity to modify the transaction to remove the exception condition. If the transaction is approved, processing continues from block 510, wherein the channel messages are queued and processed for transmission. The queue and process channel message block 510 includes a queue subprocess that combines batch transactions for processing. This block can also include a work queue approval subprocess, which validates any of the queuing and processing generated by the process. Once the channel messages are processed, the system performs the funds transfer over the channels selected by the channel selection business logic, block 516, and any exceptions that may be generated during the funds transfer or settlement processes are resolved, block 518.

As shown in FIG. 5, feedback loops allow the user to cancel or modify the transaction if exceptions are generated or the automatic selections are not appropriate. Thus, if, in step 507, the user does not approve the transaction and cancels the transaction, the process ends. However, if the user does not initially approve the transaction, but requests that the transaction be modified to better suit his or her preferences, the process receives the user modified input in preparation for reselecting the channels for the legs of the transaction, block 514. In this case, the process proceeds again from block 504 in which the channel selection business logic reselects the appropriate channel based on the modified user input and new channel leg IDs are assigned. The process then continues through the application of channel communication rules for the new channel or channels, and the transmission of messages over these channels. In the case of a deadlock condition in which two or more mutually exclusive user requirements cannot be satisfied with respect to transaction routing, the system can be configured to either abort the transaction, automatically select a particular routing option based on pre-defined business rules, or require that the user explicitly relax one of the conflicting constraints before continuing with the transaction.

The integrated transfer process 105 is intended to be an automated process that performs the fund transfer operation in a manner that is transparent to the user. The user need only specify the source and destination account, the transaction amount, and any relevant preferences. The system then derives the type of transaction involved (e.g., credit card payment, account transfer, or loan payment, etc.) and determines the best channel route based on this input.

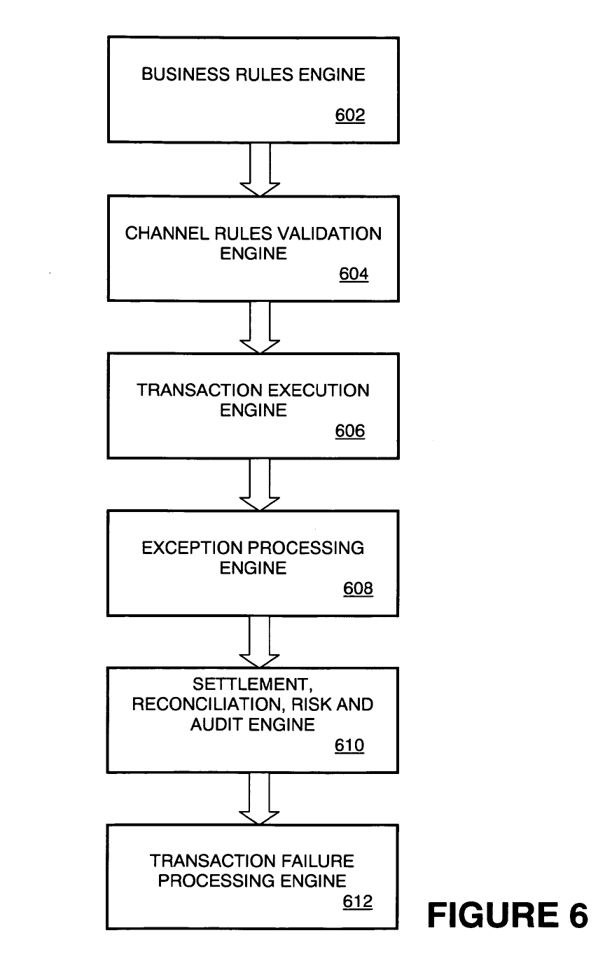

In one embodiment, the channel selection business logic, channel communication rules, and the channel message processing blocks are implemented through generic rules engines that obtain and insert appropriate channel specific data based on the business logic. FIG. 6 is a block diagram that illustrates the functional components of a multi-channel transaction system, according to an embodiment. For the system illustrated in FIG. 6, a business rules engine 602 determines the fund transfer channels used for the two legs of the transaction. The routing selection for each leg is based on the specifics of the transaction (transaction size, financial institution, etc.), and the user preferences with regard to transaction cost, delivery speed, user risk tolerance, and any other specified user preferences or requirements. A channel rules validation engine 604 validates the transaction against any defined limits set by the financial institutions and/or the networks. It also performs any authorizations to setup the transaction. After channel rules validation, a user feedback process prompts the user to approve the transaction. If approved, a transaction execution engine 606 routes the transaction over the networks selected for each leg. Network specific messaging logic is used to transfer messages over the selected networks. An exception processing engine 608 processes any exceptions that may result during the transaction, as well as any problems that may occur after the transaction, such as disputed transactions. The multi-channel transaction system also includes a transaction failure processing engine 612, which re-routes or processes any transaction that is rejected by a financial institution involved in the transaction.

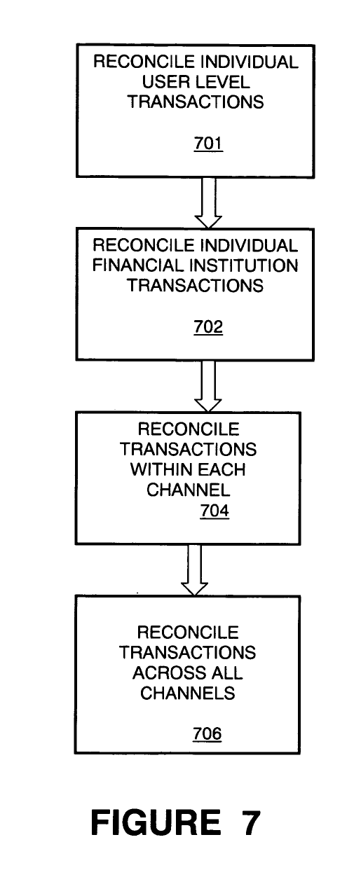

For the embodiment illustrated in FIG. 6, the system also includes a settlement, reconciliation, risk and audit engine 610. This engine performs certain reconciliation functions on several different levels in the system. FIG. 7 illustrates reconciliation of multi-channel real time transfers, under an embodiment. The reconciliation engine performs reconciliation of individual user transactions 701, and financial institution transactions 702. It reconciles processing accounts at the financial institution, as well as the net flow of funds to and from the financial institution, and can also perform reversals as necessary. The reconciliation engine also reconciles transactions within each channel (intrachannel) 704. This process reconciles balances across the different possible channels (e.g., ACH, EFT, OFX, and so on). It also provides net settlement across accounts within each channel. An interchannel reconciliation process 706 reconciles transactions across all relevant channels, and ensures that net credits and debits match up. Other reconciliation modules, such as those that reconcile transactions across all accounts and transactions for a particular entity or time period can also be included.

Embodiments may be used in any type of financial network system implementing different payment networks for the transfer of funds among various financial institutions. Client users may register multiple accounts associated with the different financial institutions using facilities provided by the financial management system server 104. The financial institutions may be any type of commercial or private entity or subdivision thereof, and may include entities that are affiliated through certain defined relationships. The transfer of funds among such financial institutions, and the client registration of multiple accounts, among other fund transfer methods are described in co-pending patent application Ser. No. 09/665,919, entitled “Method and Apparatus for Implementing Financial Transactions”, and filed on Sep. 20, 2000, which is assigned to the assignees of the present application, and which is hereby incorporated in its entirety by reference.

Likewise, embodiments may implement certain risk evaluation and ownership validation processes, such as those described in co-pending patent application Ser. No. 10/040,929, entitled “Method and Apparatus for Managing Transactions”, and filed on Dec. 31, 2001, which is assigned to the assignees of the present application, and which is hereby incorporated in its entirety by reference. Embodiments may further implement certain back office functions for record keeping, transaction monitoring, and report generation, as well as the verification and suspension of accounts and/or users, such as those described in co-pending patent application Ser. No. 10/402,885, entitled “Method and Apparatus for Managing a Financial Transaction System”, and filed on Mar. 28, 2003, which is assigned to the assignees of the present application, and which is hereby incorporated in its entirety by reference.

Aspects of the integrated transfer process described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the application integration method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the integrated transfer process is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the integrated multi-channel fund transfer system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the integrated transfer process are presented below in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

1.-20. (canceled)

21. A computer-implemented method, comprising:
receiving, by a computerized financial management system comprising one or more computers, a funds transfer request on behalf of a user, wherein the funds transfer request comprises a request to execute a financial transaction comprising a transfer of funds from a first account associated with a first financial institution to a second account associated with a second financial institution;
identifying, by the computerized financial management system, a first leg and a second leg of the financial transaction, wherein the first leg comprises a debit of the funds from the first account and the second leg comprises a credit of at least a portion of the funds into the second account;
selecting, by the computerized financial management system, a first channel for transmission of a debit transaction associated with the first leg and a second channel for transmission of a credit transaction associated with the second leg based at least in part on at least one of one or more optimization parameters, wherein the one or more optimization parameters comprise one or more user preferences comprising at least one of: a first user preference that specifies a maximum allowable transaction service cost for executing the financial transaction or a second user preference that specifies a maximum allowable time for completing execution of the financial transaction;
determining, by the computerized financial management system, one or more transmission characteristics based at least in part on the first channel and the second channel, wherein the one or more transmission characteristics comprise at least one of: a transaction service cost for executing the financial transaction or a transaction time for completing execution of the financial transaction;
transmitting, by the computerized financial management system for presentation to the user, transmission characteristic information indicative of the one or more transmission characteristics;
receiving, by the computerized financial management system responsive to transmitting the transmission characteristic information, a response on behalf of the user;
determining, by the computerized financial management system, a type of the response, wherein the type of the response comprises one of: i) an approval to initiate execution of the financial transaction, wherein the approval corresponds to an acceptance of the one or more transmission characteristics, ii) a cancellation of the funds transfer request, or iii) a request to modify at least one optimization parameter of the one or more optimization parameters; and
performing, by the computerized financial management system, additional processing associated with the funds transfer request based at least in part on the determined type of the response.

22. The method of claim 21, wherein the type of the response comprises the request to modify the at least one optimization parameter, wherein the at least one optimization parameter comprises at least one user preference, and
wherein the additional processing comprises at least one of:
identifying, based at least in part on a modification to the at least one user preference, a different channel than the first channel for transmission of the debit transaction or identifying, based at least in part on the modification to the at least one user preference, a different channel than the second channel for transmission of the credit transaction.

23. The method of claim 22, wherein the modification to the at least one user preference comprises at least one of:
an increase of the maximum allowable transaction time for completing execution of the financial transaction or an increase of the maximum allowable transaction service cost for executing the financial transaction.

24. The method of claim 22, wherein the additional processing comprises modifying, by the computerized financial management system, the at least one user preference.

25. The method of claim 21, wherein the one or more optimization parameters further comprise at least one of:
a risk tolerance, or
one or more network constraints, wherein each network constraint is associated with a respective at least one of the first channel or the second channel.

26. The method of claim 25, further comprising:
determining, by the computerized financial management system, that a first network constraint of the one or more network constraints is associated with the first channel; and
determining, by the computerized financial management system, that a second network constraint of the one or more constraints is associated with the second channel,
wherein the identifying the first channel comprises:
determining, by the computerized financial management system, that the debit transaction associated with the first leg satisfies the first network constraint, and
wherein identifying the second channel comprises:
determining, by the computerized financial management system, that the credit transaction associated with the second leg satisfies the second network constraint.

27. The method of claim 21, further comprising:
determining, by the computerized financial management system, that no available channel for transmission of the debit transaction satisfies each of at least two conflicting user preferences,
wherein identifying the first channel comprises:
identifying, by the computerized financial management system, the first channel based at least in part on one or more predefined rules different from the one or more user preferences, or
wherein identifying the first channel comprises:
transmitting, by the computerized financial management system for presentation to the user, a request for the user to modify one or more of the conflicting user preferences,
receiving, by the computerized financial management system on behalf of the user, a modification of at least one conflicting user preference of the conflicting user preferences; and
identifying, by the computerized financial management system, the first channel based at least in part on the modification of the at least one conflicting user preference.

28. The method of claim 21, further comprising:
determining, by the computerized financial management system, that no available channel for transmission of the credit transaction satisfies each of at least two conflicting user preferences,
wherein identifying the second channel comprises:
identifying, by the computerized financial management system, the second channel based at least in part on one or more predefined rules different from the one or more user preferences, or
wherein identifying the second channel comprises:
transmitting, by the computerized financial management system for presentation to the user, a request for the user to modify one or more of the conflicting user preferences,
receiving, by the computerized financial management system on behalf of the user, a modification of at least one conflicting user preference of the conflicting user preferences; and
identifying, by the computerized financial management system, the second channel based at least in part on the modification of the at least one conflicting user preference.

29. The method of claim 21, further comprising:
determining, by the computerized financial management system, that the type of response corresponds to the approval to initiate execution of the financial transaction,
wherein the additional processing comprises:
determining, by the computerized financial management system, first network communication rules associated with the first channel;
determining, by the computerized financial management system, second network communication rules associated with the second channel;
transmitting, by the computerized financial management system, the debit transaction associated with the first leg using the first channel in accordance with the first network communication rules; and
transmitting, by the computerized financial management system, the credit transaction associated with the second leg using the second channel in accordance with the second network communication rules.

30. A financial management system, comprising:
one or more communication interfaces;
at least one processor; and
at least one memory storing computer-executable instructions,
wherein the at least one processor is communicatively coupled to the one or more communication interfaces and the at least one memory and is configured to access the at least memory and execute the computer-executable instructions to:
receive, via at least a first communication interface of the one or more communication interfaces and on behalf of a user, a funds transfer request, wherein the funds transfer request comprises a request to execute a financial transaction comprising a transfer of funds from a first account associated with a first financial institution to a second account associated with a second financial institution;
identify, a first leg and a second leg of the financial transaction, wherein the first leg comprises a debit of the funds from the first account and the second leg comprises a credit of at least a portion of the funds into the second account;
select a first channel for transmission of a debit transaction associated with the first leg and a second channel for transmission of a credit transaction associated with the second leg based at least in part on at least one of one or more optimization parameters, wherein the one or more optimization parameters comprise one or more user preferences comprising at least one of: a first user preference that specifies a maximum allowable transaction service cost for executing the financial transaction or a second user preference that specifies a maximum allowable time for completing execution of the financial transaction;
determine one or more transmission characteristics based at least in part on the first channel and the second channel, wherein the one or more transmission characteristics comprise at least one of: a transaction service cost for executing the financial transaction or a transaction time for completing execution of the financial transaction;
direct at least a second communication interface of the one or more communication interfaces to transmit, for presentation to the user, transmission characteristic information indicative of the one or more transmission characteristics;
receive, via at least a third communications interface of the one or more communications interfaces and responsive to transmission of the transmission characteristic information, a response on behalf of the user;
determine a type of the response, wherein the type of the response comprises one of: i) an approval to initiate execution of the financial transaction, wherein the approval corresponds to an acceptance of the one or more transmission characteristics, ii) a cancellation of the funds transfer request, or iii) a request to modify at least one optimization parameter of the one or more optimization parameters; and
perform additional processing associated with the funds transfer request based at least in part on the determined type of the response.

31. The system of claim 30, wherein the type of the response comprises the request to modify the at least one optimization parameter, wherein the at least one optimization parameter comprises at least one user preference, and
wherein the additional processing comprises at least one of:
identifying, based at least in part on a modification to the at least one user preference, a different channel than the first channel for transmission of the first transaction or identifying, based at least in part on a modification to the at least one user preference, a different channel than the second channel for transmission of the second transaction.

32. The system of claim 31,
wherein the modification to the at least one user preference comprises at least one of:
an increase of the maximum allowable transaction time for completing execution of the financial transaction or an increase of the maximum allowable transaction service cost for executing the financial transaction.

33. The system of claim 31, wherein the additional processing comprises modifying the at least one user preference.

34. The system of claim 30, wherein the one or more optimization parameters further comprise at least one of:
a risk tolerance, or
one or more network constraints, wherein each network constraint is associated with a respective at least one of: the first channel or the second channel.

35. The system of claim 34, wherein, the at least one processor is further configured to execute the computer-executable instructions to:
determine that a first network constraint of the one or more network constraints is associated with the first channel;
determine that a second network constraint of the one or more network constraints is associated with the second channel;
determine that the debit transaction associated with the first leg satisfies the first network constraint; and
determine that the credit transaction associated with the second leg satisfies the second network constraint.

36. The system of claim 30, wherein the at least one processor is further configured to execute the computer-executable instructions to:
determine that no available channel for transmission of the debit transaction or no available channel for transmission of the credit transaction satisfies each of at least two conflicting user preferences, and
identify the first channel or the second channel based at least in part on one or more predefined rules different from the one or more user preferences, or
identify the first channel or the second channel by executing the computer-executable instructions to:
transmit, via at least a fourth communication interface of the one or more communication interfaces and for presentation to the user, a request for the user to modify one or more of the conflicting user preferences,
receive, via at least the fourth communications interface and on behalf of the user, an indication of a modification to at least one conflicting user preference of the conflicting user preferences, and
identify the first channel or the second channel based at least in part on the modification to the at least one conflicting user preference.

37. One or more non-transitory computer-readable media comprising computer-executable instructions responsive to execution by one or more computer processors cause operations to be performed comprising:
identifying a funds transfer request received on behalf of a user, wherein the funds transfer request comprises a request to execute a financial transaction comprising a transfer of funds from a first account at a first financial institution to a second account at a second financial institution;
identifying a first leg and a second leg of the financial transaction, wherein the first leg comprises a debit of the funds from the first account and the second leg comprises a credit of at least a portion of the funds into the second account;
selecting a first channel for transmission of a debit transaction associated with the first leg and a second channel for transmission of a credit transaction associated with the second leg based at least in part on at least one of one or more optimization parameters, wherein the one or more optimization parameters comprise one or more user preferences comprising at least one of: a first user preference that specifies a maximum allowable transaction service cost for executing the financial transaction or a second user preference that specifies a maximum allowable time for completing execution of the financial transaction;
determining one or more transmission characteristics based at least in part on the first channel and the second channel, wherein the one or more transmission characteristics comprise at least one of: a transaction service cost for executing the financial transaction or a transaction time for completing execution of the financial transaction;
transmitting, for presentation to the user, transmission characteristic information indicative of the one or more transmission characteristics;
identifying, responsive to transmitting the transmission characteristic information, a response received on behalf of the user;
determining a type of the response, wherein the type of the response comprises one of: i) an approval to initiate execution of the financial transaction, wherein the approval corresponds to an acceptance of the one or more transmission characteristics associated with execution of the financial transaction, ii) a cancellation of the funds transfer request, or iii) a request to modify at least one optimization parameter of the one or more optimization parameters; and
performing additional processing associated with the funds transfer request based at least in part on the determined type of the response.

38. The one or more computer-readable media of claim 37, wherein the type of the response comprises the request to modify the at least one optimization parameter, wherein the at least one optimization parameter comprises at least one user preference, and
wherein the additional processing comprises at least one of:
identifying, based at least in part on a modification to the at least user preference, a different channel than the first channel for transmission of the debit transaction or identifying, based at least in part on the modification to the at least one user preference, a different channel than the second channel for transmission of the credit transaction, wherein the modification to the at least one user preference comprises at least one of: an increase of the maximum allowable transaction service cost for executing the financial transaction or an increase of the maximum allowable time for completing execution of the financial transaction.

39. The system of claim 30, wherein each of the at least one first communication interface, the at least one second communication interface, and the at least one third communication interface comprise at least one common communication interface of the one or more communications interfaces.

40. The method of claim 21, wherein the type of the response comprises the request to modify the at least one optimization parameter, wherein the at least one optimization parameter comprises a transaction size, and
wherein the additional processing comprises at least one of:
transmitting, by the computerized financial management system, the debit transaction using the first channel based at least in part on a modification to the transaction size or transmitting, by the computerized financial management system, the credit transaction using the second channel based at least in part on the modification to the transaction size, wherein the modification to the transaction size comprises a decrease of the transaction size.
